(19) United States
(12) Patent Application Publication
(10) Pub. No.: US 2004/0222581 A1
(43) Pub. Date: Nov. 11, 2004

(54) Folding device

(75) Inventors: Joachim Hoffmann, Steinheim (DE); Bodo Tegtmeier, Alfdorf-pfahlbronn (DE); Georg Dannemann, Backnang (DE); Eberhard Krieger, Weinstadt-Struempfelbach (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 10/768,013

(22) Filed: Feb. 2, 2004

(30) Foreign Application Priority Data
May 8, 2003 (DE) 203 07 170.0

(51) Int. Cl. B41F 13/64

(52) U.S. Cl. 270/16

(57) ABSTRACT

A folding device includes a folding machine with a folding unit, and a prefolding apparatus for prefolding a sheet before it is feeded into the folding unit of the folding machine. The prefolding apparatus includes a sheet stacking apparatus, on which a sheet stack is stored. A perforating or scoring device perforates or creases a sheet fed from the sheet stacking apparatus along a longitudinal center line thereof. A plow folding unit folds the perforated or creased sheet around the longitudinal center line.

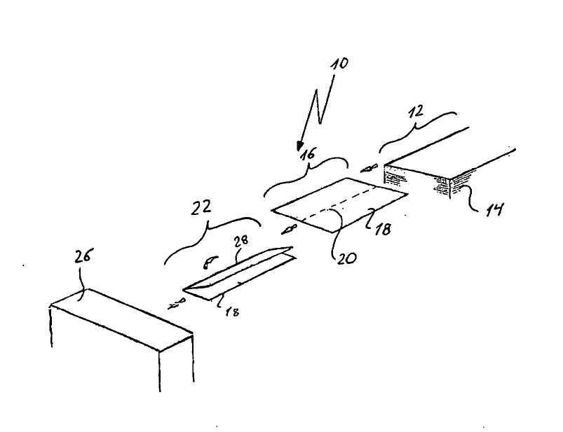

### BACKGROUND OF THE INVENTION

1. Field of the Invention

The invention is in the field of sheet folding devices.

2. Description of the Background Art

DE 34 31 611 C2 discloses feeding individual sheets from a sheet stack to a buckle folding unit of a folding machine over an oblique tape table. The buckle folding unit must therefore be dimensioned to correspond to the width of the sheet. The processing of very wide sheets is not possible with relatively small buckle folding units.

### SUMMARY OF THE INVENTION

The invention relates to a folding device comprising a folding machine including a folding unit into which a sheet is feeded.

The object of the invention is to provide a folding device which is able to process relatively wide sheet material using relatively small folding machines.

This object is achieved by a folding device comprising a folding machine including a folding unit, and a prefolding apparatus for prefolding a sheet before it is feeded into said folding unit of said folding machine, wherein in said prefolding apparatus the following are arranged one after another in the sheet feeding direction

a sheet stacking apparatus, on which a sheet stack is stored,

a perforating or scoring device, which perforates or creases a sheet fed from said sheet stacking apparatus along a longitudinal center line thereof, and

a plow folding unit, which folds said perforated or creased sheet around said longitudinal center line.

The prefolding apparatus of the folding machine according to the invention makes it possible, with relatively little expenditure on construction, to reduce the width of a sheet material before it runs into the folding unit, so that relatively small-dimensioned folding machines can be used to fold originally relatively wide sheet material. Existing small folding machines can be retrofitted with the prefolding apparatus, which means that the folding range of this folding machine is expanded.

### BRIEF DESCRIPTION OF THE DRAWING

Exemplary embodiments of the invention will be explained in more detail below using the drawing, which shows a prefolding apparatus in a perspective, partly schematic view.

### DETAILED DESCRIPTION OF THE INVENTION

A folding device according to the invention comprises a prefolding apparatus 10 shown in the FIGURE and having a sheet stacking apparatus 12, on which a sheet stack 14 is arranged. Provided adjacent to the sheet stacking apparatus 12 is a perforating or scoring device 16, to which a sheet 18 is fed from the sheet stack 14. The perforating and scoring device 16 normally has a pair of knife shafts, to which cutting or scoring tools are fitted in such a way that a perforation or crease is made along the longitudinal center line 20 in the sheet 18 which passes through the pair of knife shafts. After the perforating or scoring device 16, the scored or perforated sheet 18 is fed to a plow folding unit 22, in which the sheet 18 is folded about its longitudinal center line 20. The sheet 18 is then fed to the inlet of a folding machine 26, preferably a buckle folding unit, in which it is processed further. In the process, the sheet 18 is introduced in such a way that its folded edge 28 extends in the inlet direction.

The sheet is transported in a rectilinear movement from the sheet stacking apparatus 12 as far as the folding machine 26. Since the width of the sheet 18 introduced into the folding machine 26 is half as great as the width of a sheet on the sheet stack 14, it is possible to use a relatively small folding machine 26 in spite of an originally very wide sheet 18. By arranging the perforating and scoring device 16 and the plow folding unit 22 between the sheet stack and the buckle folding unit of the folding machine, known from DE 34 31 611 C2, this folding machine can also be used for folding larger sheets than normal.

1. A folding device comprising a folding machine including a folding unit, and a prefolding apparatus for prefolding a sheet before it is fed into said folding unit of said folding machine, wherein in said prefolding apparatus the following are arranged one after another in the sheet feeding direction,
a sheet stacking apparatus, on which a sheet stack is stored,
a perforating or scoring device, which perforates or creases a sheet fed from said sheet stacking apparatus along a longitudinal center line thereof, and
a plow folding unit, which folds said perforated or creased sheet around said longitudinal center line.
